(19) United States
(12) Patent Application Publication
(10) Pub. No.: US 2025/0224229 A1
(43) Pub. Date: Jul. 10, 2025

(54) WIDE-WAVELENGTH RANGE DEMODULATION METHOD FOR CASCADED FBGS OF SIX-AXIS MULTIDIMENSIONAL STRAIN SENSOR BASED ON TUNABLE DUAL-PEAK RESONANCE LPFG

(71) Applicant: TAIYUAN UNIVERSITY OF TECHNOLOGY, TAIYUAN CITY (CN)

(72) Inventors: XIAO DENG, TAIYUAN CITY (CN); BIN JIA, TAIYUAN CITY (CN); CHAO DU, TAIYUAN CITY (CN); ZHUOKE QIN, TAIYUAN CITY (CN); LIQIN CUI, TAIYUAN CITY (CN); LIN ZHANG, TAIYUAN CITY (CN); LI ZHANG, TAIYUAN CITY (CN)

(21) Appl. No.: 19/010,880

(22) Filed: Jan. 6, 2025

(30) Foreign Application Priority Data
Jan. 8, 2024 (CN) 202410025682.5

(51) Int. Cl. G01B 11/16

(52) U.S. Cl. CPC G01B 11/165

(57) ABSTRACT

Provided is a wide-wavelength range demodulation method for cascaded fiber Bragging gratings (FBGs) of a six-axis multidimensional strain sensor. Laser emitted by a broadband light source is filtered by a dual-peak resonance LPFG to form a transmittance spectrum; a piezoelectric ceramic is controlled by a signal processing system to move, so that a dual-peak resonance LPFG fixed on the piezoelectric ceramic bends and deforms, to change a spectrum filtered by the dual-peak resonance LPFG; and laser passing through the dual-peak resonance LPFG enters a circulator through an optical isolator and then is incident to the cascaded FBGs of the six-axis strain sensor; and reflected light of the cascaded FBGs enters a photoelectric detector through a circulator and an attenuator, the photoelectric converter is configured to: convert a sum of intensities of reflected light of the cascaded FBGs into a voltage value, input the voltage value into the signal processing system.

### CROSS REFERENCE TO RELATED APPLICATION

This patent application claims the benefit and priority of Chinese Patent Application No. 2024100256825, filed with the China National Intellectual Property Administration on Jan. 8, 2024, the disclosure of which is incorporated by reference herein in its entirety as part of the present application.

### TECHNICAL FIELD

The present disclosure belongs to the field of optical fiber sensing signal analysis technologies, and more specifically, relates to an implementation method for obtaining a center wavelength of cascaded fiber Bragging gratings (FBGs) in a sensing process.

### BACKGROUND

A center wavelength of an FBG has very good sensitivity and linearity to both a temperature and strain response, and therefore, the FBG is a common optical fiber sensing element. A need for sensing signal analysis increases with further development of a fiber grating sensing technology. Especially for monitoring a large-range spatial principal strain, a sensor includes six cascaded FBGs, with a large center wavelength offset range. A demodulation range of each FBG is at least 20 nm, and therefore, a demodulation angle of the entire sensor is at least 120 nm. It is difficult for a common demodulation method to meet center wavelength demodulation needs of the cascaded FBGs within a wide wavelength range.

An edge filtering method can be used to implement conversion from a center wavelength to an intensity of reflected light without scanning an entire spectrum, is featured in a simple structure, a wide wavelength demodulation range, and the like, and has a great application advantage in demodulating strain sensing signals of large-range cascaded FBGs. At present, a previously reported edge filter mainly includes three types of a tunable Fabry-Perot (F-P), an interferometer, and a long-period fiber grating (LPFG). Methods based on the tunable F-P and interferometer are small in demodulation range, and an edge filtering method based on linear sidebands of an LPFG is simple in structure and high in demodulation precision. However, a conventional LPFG is limited in spectral range (less than tens of nanometers), and cannot be configured to simultaneously implement wide-wavelength range (greater than 120 nm) demodulation of the cascaded FBGs. A spectrum demodulation range (as shown in FIGS. 1A-1B) can be effectively expanded to be far greater than 120 nm through four linear sidebands of a dual-peak resonance LPFG. This helps wide-wavelength range demodulation for a signal of the cascaded FBGs in a sensor for monitoring a spatial principal strain.

### SUMMARY

To resolve the disadvantages in the conventional technology, the present disclosure provides a method capable of demodulating, based on a dual-peak resonance long-period fiber grating (LPFG), cascaded FBGs within a wide-wavelength range (120 nm). The method implements wide-wavelength range demodulation for the cascaded FBGs by using the LPFG with dual-peak response as a filter through an edge filtering method, and application of the method in related technical fields is also provided.

To achieve the above objective, the present disclosure adopts the following technical solutions:

A wide-wavelength range demodulation method for cascaded FBGs of a six-axis multidimensional strain sensor based on a tunable dual-peak resonance LPFG is implemented by using a demodulation system for the cascaded FBGs based on the tunable dual-peak resonance LPFG. As shown in FIG. 2, the demodulation system for the cascaded FBGs includes a broadband light source 1, a piezoelectric ceramic 2, a dual-peak resonance LPFG 3, an optical isolator 4, a circulator 5, an attenuator 6, a photoelectric detector 7, a signal processing system 8, and a computer 9. The broadband light source 1 is sequentially connected to the dual-peak resonance LPFG 3, the optical isolator 4, the circulator 5, the attenuator 6, and the photoelectric detector 7 through an optical fiber, where the dual-peak resonance LPFG 3 is fixed on the piezoelectric ceramic 2, and a six-axis strain sensor 10 is connected to the circulator 5; and the photoelectric detector 7, the signal processing system 8, and the computer 9 are connected through an electric wire, where the signal processing system 8 is connected to the piezoelectric ceramic 2.

In the demodulation method, the dual-peak resonance LPFG 3 is used as a filter, and is configured to filter broadband laser emitted by the broadband light source 1 into a spectrum with four linear sidebands, in other words, laser emitted by the broadband light source 1 is filtered by the dual-peak resonance LPFG 3 to form a transmittance spectrum with four linear sidebands, where a wavelength range of the four linear sidebands is far greater than 120 mm; the piezoelectric ceramic 2 is controlled by the signal processing system 8 to move, so that the dual-peak resonance LPFG 3 fixed on the piezoelectric ceramic 2 bends and deforms, to change a spectrum filtered by the dual-peak resonance LPFG 3; and laser passing through the dual-peak resonance LPFG 3 enters the circulator 5 through the optical isolator 4 and then is incident to the cascaded FBGs of the six-axis strain sensor 10, where light filtered by the dual-peak resonance LPFG 3 is only unidirectionally transmitted into the circulator 5 via the optical isolator 4, and light in the circulator 5 is not returned into the optical isolator 4. Reflected light of the cascaded FBGs sequentially passes through the circulator 5 and the attenuator 6 to enter the photoelectric detector 7; the attenuator 6 is configured to adjust an intensity of passed light to prevent the intensity of passed light from exceeding a measurement range of the photoelectric detector 7, and the photoelectric detector 7 is configured to: convert a sum of intensities of reflected light of the cascaded FBGs of the six-axis strain sensor 10 into a voltage value, and input the voltage value into the signal processing system 8 for storage.

Further, the photoelectric detector 7 is configured to: obtain a sum of intensities of reflected light of seven FBGs (including six strain sensing units and one temperature sensing unit) of the six-axis strain sensor 10, and convert the sum into a voltage value. Therefore, the key of the present disclosure is to perform seven controls on the spectrum of the dual-peak resonance LPFG 3 via the piezoelectric ceramic 2, so that the intensity of the reflected light is changed seven times when center wavelengths of the cascaded FBGs of the six-axis strain sensor 10 are not changed, and voltage values converted by the photoelectric detector 7 seven times are resolved to obtain center wavelength values of seven cascaded FBGs.

Further, the piezoelectric ceramic 2 is controlled by the signal processing system 8 to move, so that the dual-peak resonance LPFG 3 fixed on the piezoelectric ceramic 2 bends and deforms. This changes the transmittance spectrum of the dual-peak resonance LPFG 3. After the transmittance spectrum of the LPFG 3 is changed, the intensities of the reflected light of the cascaded FBGs change while the center wavelengths of the cascaded FBGs of the six-axis strain sensor 10 are not changed, so that an output voltage of the photoelectric detector 7 finally changes. Therefore, the piezoelectric ceramic 2 of the signal processing system 8 is controlled to move seven times. In this case, seven different voltage values are correspondingly output by the photoelectric detector 7, and are recorded in the signal processing system 8. The signal processing system 8 is configured to substitute the seven recorded voltage values into a demodulation model to obtain seven center wavelengths of the cascaded FBGs of the six-axis strain sensor 10, and the seven center wavelengths are displayed on the computer 9. In this way, wide-wavelength range (greater than 120 mm) demodulation for seven cascaded FBGs in the six-axis strain sensor 10 is implemented.

Further, the six-axis strain sensor 10 is a fiber grating six-axis strain sensing unit, as shown in FIG. 4, and has six strain sensing units of a same structure, that are arranged in six spatial directions of X, Y, Z, XY, XZ, and YZ, and also has a temperature sensing unit arranged inside a base of the six-axis multidimensional strain sensor to achieve temperature compensation in a strain measurement process of the six-axis multidimensional strain sensor. Specifically, the fiber grating six-axis strain sensing unit includes a bracket 10-1, the base 10-10, the six strain sensing units that are respectively disposed in six directions and have a same structure, the temperature sensing unit, an optical fiber 10-5, a cylindrical encapsulation structure 10-8, and a temperature FBG 10-9. Each of the six strain sensing units includes two circular discs 10-2, a hollow cylindrical tube 10-3, and a strain FBG 10-4; and the temperature sensing unit includes a cover plate 10-6, a cylindrical cavity 10-7, and the cylindrical encapsulation structure 10-8. Components other than the strain FBG 10-4 and the optical fiber 10-5 are integrally manufactured through 3D printing, and are mutually integrated. The specific structural description is as follows.

The bracket 10-1 is configured to support the six stain sensing units in the six spatial directions of X, Y, Z, XY, XZ, and YZ, and each of the strain sensing units includes two circular discs 10-2, one hollow cylindrical tube 10-3, and a strain FBG 10-4 encapsulated inside the hollow cylindrical tube 10-3. The FBG 10-4 is located in a center of the hollow cylindrical tube 10-3, and is fixed with an inner wall of the tube by using a fixative, so that the FBG 10-4 has synchronous deformation with the hollow cylindrical tube 10-3 during strain measurement while the FBG 10-4 is prevented from a chirp phenomenon. The two circular discs 10-2 are arranged outside the hollow cylindrical tube 10-3, the hollow cylindrical tube 10-3 and the two circular discs 10-2 form a dumbbell-like hollow structure, and the circular disc 10-2 is configured to prevent sliding relative to a measured object in a measurement process. Bottoms of the six strain sensing units are fixed on the base 10-10. The base 10-10 is of a hollow cylindrical structure, and is internally nested with a coaxial hollow circular tube, the cylindrical encapsulation structure 10-8 and the temperature FBG 10-9 are disposed in the circular tube, the cover plate 10-6 is disposed on a top of the circular tube, and a through hole for allowing the strain FBG 10-4 to pass through is formed in the middle of the cover plate. The cylindrical cavity 10-7 is provided between the cylindrical encapsulation structure 10-8 and the cover plate 10-6.

Seven FBGs (including six strain FBGs-4 and one temperature FBG 10-9) are cascaded together and arranged in the six-axis strain sensor in sequence. One end that is of the hollow cylindrical tube 10-3 and that is close to the base 10-10 is defined as an inner end, and the other end of the hollow cylindrical tube 10-3 is defined as an outer end. A first FBG 10-4 gets in from the outer end of the hollow cylindrical tube 10-3 in the YZ direction and is fixed in the hollow cylindrical tube 10-3 in the YZ direction; after the first FBG 10-4 is fixed, an optical fiber guided out from the outer end of the hollow cylindrical tube 10-3 in the YZ direction gets in the hollow cylindrical tube 10-3 in the Y direction, and a second FBG 10-4 is fixed in the hollow cylindrical tube 10-3 in the Y direction; an optical fiber guided out from the inner end of the hollow cylindrical tube 10-3 in the Y direction gets in from the inner end of the hollow cylindrical tube 10-3 in the XY direction, and a third FBG 10-4 is fixed in the hollow cylindrical tube 10-3 in the XY direction; an optical fiber guided out from the outer end of the hollow cylindrical tube 10-3 in the XY direction gets in from the outer end of the hollow cylindrical tube 10-3 in the X direction, and a fourth FBG 10-4 is fixed in the hollow cylindrical tube 10-3 in the X direction; an optical fiber guided out from the inner end of the hollow cylindrical tube 10-3 in the X direction gets in from the inner end of the hollow cylindrical tube 10-3 in the XZ direction, and a fifth FBG 10-4 is fixed in the hollow cylindrical tube 10-3 in the XZ direction; an optical fiber guided out from the outer end of the hollow cylindrical tube 10-3 in the XZ direction gets in from the outer end of the hollow cylindrical tube 10-3 in the Z direction, and a sixth FBG 10-4 is fixed in the hollow cylindrical tube 10-3 in the Z direction; and an optical fiber (a tail end of which is provided with the temperature FBG (9)) guided out from an inner end of the hollow cylindrical tube (3) in the Z direction gets into the cavity (10-7) of the base (10-10), thereby completing arrangement of the seven FBGs.

The one temperature FBG 10-9 is arranged in a cavity of the base 10-10, to eliminate temperature interference in the measurement process; and the temperature FBG 10-9 is only affected by a temperature and is not affected by deformation of an external sensor, and is configured to perform temperature compensation as the temperature sensing unit. The temperature sensing unit is arranged in the base 10-10, and a cylindrical cavity 10-7 is provided in the base 10-10. An FBG 10-4 fixed on an optical fiber guided out from an inner end of a hollow cylindrical tube 10-3 in the Z direction passes through the circular cover plate 10-6 with a hole, and then is fixed in the cylindrical encapsulation structure 10-8 by using a fixative. A diameter of the cylindrical encapsulation structure 10-8 is less than that of the cavity 10-7 in which a hollow groove for allowing the optical fiber to pass through is provided. The cylindrical encapsulation structure 10-8 in which the FBG 10-4 is fixed is placed in the cavity 10-7, and the cavity is sealed via the cover plate 10-6, making the encapsulated temperature FBG 10-9 in the cavity to be only affected by a temperature and not affected by external force, to finally form the temperature sensing unit of the six-axis multidimensional strain sensor.

The finally designed fiber grating six-axis strain sensor is capable of converting strains, in the six spatial directions of X, Y, Z, XY, XZ, and YZ, inside the measured object into changes of center wavelength values (λ_{FBG}) corresponding to cascaded FBGs of the six-axis multidimensional strain sensor to implement measurement of the six-axis multidimensional strain sensor.

Further, the demodulation model is as follows: during spatial strain monitoring, seven FBGs (six FBGs are strain sensing units, and one FBG is a temperature sensing unit) need to be cascaded, and therefore, the demodulation model is provided for describing the seven cascaded FBGs. Seven FBGs with different center wavelengths (FBGX, FBGYZ, FBGXY, FBGY, FBGXZ, FBGZ, and FBGT) are sequentially distributed on four linear sidebands of the dual-peak resonance LPFG 3, and I1 to I7 are ranges in which the center wavelength of each FBG deviates (as shown in FIG. 3(A)). The piezoelectric ceramic 2 is controlled by the signal processing system 8, so that the transmittance spectrum of the dual-peak resonance LPFG 3 changes regularly in sequence, and is sequentially recorded as spectrums a-g (as shown in FIG. 3(B)).

When the transmittance spectrum of the dual-peak resonance LPFG 3 is a, a correspondence between a center wavelength λᵢ (i=1-7) of the FBG within the ranges of I1 to I7 and light intensity (L) is represented as a linear model:

$${L}_{ai} = {k}_{ai} {λ}_{i} + {m}_{ai} \qquad ( 1 )$$

A signal acquired by the photoelectric detector 7 is a total intensity of reflected light within the seven ranges, and the total intensity of reflected light of seven FBGs in an optical path can be converted into a voltage value (U). An output voltage Uₐ of the photoelectric detector 7 is represented as formula (2), where R is a conversion coefficient between an intensity of input light of the photoelectric detector 7 and the output voltage U, and is an inherent characteristic of the photoelectric detector 7.

$${U}_{a} = β {\sum }_{i = 1}^{7} {L}_{ai} = β [ ( {k}_{a 1} {λ}_{1} + {k}_{a 2} {λ}_{2} + {k}_{a 3} {λ}_{3} + {k}_{a 4} {λ}_{4} + {k}_{a 5} {λ}_{5} + {k}_{a 6} {λ}_{6} + {k}_{a 7} {λ}_{7} ) + {\sum }_{i = 1}^{7} {m}_{ai} ] \qquad ( 2 )$$

When the transmittance spectrum of the dual-peak resonance LPFG 10 is j (j=a−g), a voltage Uⱼ output by the photoelectric detector 7 is as follows:

$${U}_{j} = β {\sum }_{i = 1}^{7} {L}_{ji} \qquad ( 3 )$$

In a complete demodulation process (the spectrum of the dual-peak resonance LPFG 3 is controlled seven times via the piezoelectric ceramic 2), seven voltage values (Uₐ to U_{g}) are obtained by the photoelectric detector 7. According to the formulas (1) to (3), the following is obtained in a demodulation process:

$${U}_{a} = β {\sum }_{i = 1}^{7} {L}_{ai} = β [ ( {k}_{a 1} {λ}_{1} + {k}_{a 2} {λ}_{2} + {k}_{a 3} {λ}_{3} + {k}_{a 4} {λ}_{4} + {k}_{a 5} {λ}_{5} + {k}_{a 6} {λ}_{6} + {k}_{a 7} {λ}_{7} ) + {\sum }_{i = 1}^{7} {m}_{ai} ] \qquad ( 4 )$$

$${U}_{b} = β {\sum }_{i = 1}^{7} {L}_{bi} = β [ ( {k}_{b 1} {λ}_{1} + {k}_{b 2} {λ}_{2} + {k}_{b 3} {λ}_{3} + {k}_{b 4} {λ}_{4} + {k}_{b 5} {λ}_{5} + {k}_{b 6} {λ}_{6} + {k}_{b 7} {λ}_{7} ) + {\sum }_{i = 1}^{7} {m}_{bi} ]$$

$${U}_{c} = β {\sum }_{i = 1}^{7} {L}_{ci} = β [ ( {k}_{c 1} {λ}_{1} + {k}_{c 2} {λ}_{2} + {k}_{c 3} {λ}_{3} + {k}_{c 4} {λ}_{4} + {k}_{c 5} {λ}_{5} + {k}_{c 6} {λ}_{6} + {k}_{c 7} {λ}_{7} ) + {\sum }_{i = 1}^{7} {m}_{ci} ]$$

$${U}_{d} = β {\sum }_{i = 1}^{7} {L}_{di} = β [ ( {k}_{d 1} {λ}_{1} + {k}_{d 2} {λ}_{2} + {k}_{d 3} {λ}_{3} + {k}_{d 4} {λ}_{4} + {k}_{d 5} {λ}_{5} + {k}_{d 6} {λ}_{6} + {k}_{d 7} {λ}_{7} ) + {\sum }_{i = 1}^{7} {m}_{di} ]$$

$${U}_{e} = β {\sum }_{i = 1}^{7} {L}_{ei} = β [ ( {k}_{e 1} {λ}_{1} + {k}_{e 2} {λ}_{2} + {k}_{e 3} {λ}_{3} + {k}_{e 4} {λ}_{4} + {k}_{e 5} {λ}_{5} + {k}_{e 6} {λ}_{6} + {k}_{e 7} {λ}_{7} ) + {\sum }_{i = 1}^{7} {m}_{ei} ]$$

$${U}_{f} = β {\sum }_{i = 1}^{7} {L}_{fi} = β [ ( {k}_{f 1} {λ}_{1} + {k}_{f 2} {λ}_{2} + {k}_{f 3} {λ}_{3} + {k}_{f 4} {λ}_{4} + {k}_{f 5} {λ}_{5} + {k}_{f 6} {λ}_{6} + {k}_{f 7} {λ}_{7} ) + {\sum }_{i = 1}^{7} {m}_{fi} ]$$

$${U}_{g} = β {\sum }_{i = 1}^{7} {L}_{gi} = β [ ( {k}_{g 1} {λ}_{1} + {k}_{g 2} {λ}_{2} + {k}_{g 3} {λ}_{3} + {k}_{g 4} {λ}_{4} + {k}_{g 5} {λ}_{5} + {k}_{g 6} {λ}_{6} + {k}_{g 7} {λ}_{7} ) + {\sum }_{i = 1}^{7} {m}_{gi} ]$$

M is let to represent a constant item in the formula (4):

$${M}_{j} = {\sum }_{1}^{7} {m}_{ji} \qquad ( 5 )$$

The following can be obtained from the formulas (4) and (5):

$$( \frac{1}{β} ) ( \begin{matrix}{U}_{a} \\ {U}_{b} \\ {U}_{c} \\ {U}_{d} \\ {U}_{e} \\ {U}_{f} \\ {U}_{g}\end{matrix} ) = ( \begin{matrix}{k}_{a 1} & {k}_{a 2} & {k}_{a 3} & {k}_{a 4} & {k}_{a 5} & {k}_{a 6} & {k}_{a 7} \\ {k}_{b 1} & {k}_{b 2} & {k}_{b 3} & {k}_{b 4} & {k}_{b 5} & {k}_{b 6} & {k}_{b 7} \\ {k}_{c 1} & {k}_{c 2} & {k}_{c 3} & {k}_{c 4} & {k}_{c 5} & {k}_{c 6} & {k}_{c 7} \\ {k}_{d 1} & {k}_{d 2} & {k}_{d 3} & {k}_{d 4} & {k}_{d 5} & {k}_{d 6} & {k}_{d 7} \\ {k}_{e 1} & {k}_{e 2} & {k}_{e 3} & {k}_{e 4} & {k}_{e 5} & {k}_{e 6} & {k}_{e 7} \\ {k}_{f 1} & {k}_{f 2} & {k}_{f 3} & {k}_{f 4} & {k}_{f 5} & {k}_{f 6} & {k}_{f 7} \\ {k}_{g 1} & {k}_{g 2} & {k}_{g 3} & {k}_{g 4} & {k}_{g 5} & {k}_{g 6} & {k}_{g 7}\end{matrix} ) ( \begin{matrix}{λ}_{1} \\ {λ}_{2} \\ {λ}_{3} \\ {λ}_{4} \\ {λ}_{5} \\ {λ}_{6} \\ {λ}_{7}\end{matrix} ) + ( \begin{matrix}{M}_{a} \\ {M}_{b} \\ {M}_{c} \\ {M}_{d} \\ {M}_{e} \\ {M}_{f} \\ {M}_{g}\end{matrix} ) \qquad ( 6 )$$

Finally, a linear mathematical model for the demodulation process in the present disclosure is obtained, as shown in the formula (7). In the mathematical model, both a linear coefficient kⱼᵢ (j=a to j, and i=1-7) and constant items Mₐ to M_{g} are determined based on the linear sidebands of the transmittance spectrum of the dual-peak resonance LPFG 3, and both are known. Therefore, when the output voltages Uₐ to U_{g} of the photoelectric detector 7 are known, center wavelengths (λ₁ to λ₇) of seven cascaded FBGs in the six-axis strain sensor 10 are calculated.

$$( \begin{matrix}{λ}_{1} \\ {λ}_{2} \\ {λ}_{3} \\ {λ}_{4} \\ {λ}_{5} \\ {λ}_{6} \\ {λ}_{7}\end{matrix} ) = ( \frac{1}{β} ) {( \begin{matrix}{k}_{a 1} & {k}_{a 2} & {k}_{a 3} & {k}_{a 4} & {k}_{a 5} & {k}_{a 6} & {k}_{a 7} \\ {k}_{b 1} & {k}_{b 2} & {k}_{b 3} & {k}_{b 4} & {k}_{b 5} & {k}_{b 6} & {k}_{b 7} \\ {k}_{c 1} & {k}_{c 2} & {k}_{c 3} & {k}_{c 4} & {k}_{c 5} & {k}_{c 6} & {k}_{c 7} \\ {k}_{d 1} & {k}_{d 2} & {k}_{d 3} & {k}_{d 4} & {k}_{d 5} & {k}_{d 6} & {k}_{d 7} \\ {k}_{e 1} & {k}_{e 2} & {k}_{e 3} & {k}_{e 4} & {k}_{e 5} & {k}_{e 6} & {k}_{e 7} \\ {k}_{f 1} & {k}_{f 2} & {k}_{f 3} & {k}_{f 4} & {k}_{f 5} & {k}_{f 6} & {k}_{f 7} \\ {k}_{g 1} & {k}_{g 2} & {k}_{g 3} & {k}_{g 4} & {k}_{g 5} & {k}_{g 6} & {k}_{g 7}\end{matrix} )}^{- 1} ( \begin{matrix}{U}_{a} - {M}_{a} \\ {U}_{b} - {M}_{b} \\ {U}_{c} - {M}_{c} \\ {U}_{d} - {M}_{d} \\ {U}_{e} - {M}_{e} \\ {U}_{f} - {M}_{f} \\ {U}_{g} - {M}_{g}\end{matrix} ) \qquad ( 7 )$$

The specific working principle and innovation point of the present disclosure lies in that:

The present disclosure discloses a wide-wavelength range (greater than 120 nm) demodulation method for cascaded FBGs. A spectrum of a dual-peak resonance LPFG 3 is controlled via a piezoelectric ceramic 2 to change four linear sidebands of the spectrum, so that the total intensities of reflected light of cascaded FBGs distributed on the four linear sidebands are changed. Center wavelengths (k₁ to k₇) of seven cascaded FBGs in a six-axis strain sensor 10 are obtained according to total output voltages (Uₐ to U_{g}) of the photoelectric detector 7 under seven control cases of the dual-peak resonance LPFG 3 and a linear demodulation model.

The present disclosure has the following beneficial effects:

The spectrum of the dual-peak resonance LPFG 3 is controlled to demodulate the center wavelengths of the seven cascaded FBGs in the six-axis strain sensor 10 via one optical path through the edge filtering method, and a demodulation range is greater than 120 nm. The present disclosure breaks through the problem of demodulating a plurality of FBGs via one optical path through the edge filtering method, and can implement wide-wavelength range demodulation for the six-axis strain sensor 10 in the spatial strain measurement process while a demodulation optical path is optimized. Manufacturing costs of units are low, and the optical path of the entire demodulation system is not complex, and therefore, the present disclosure can be applied to the field of sensing signal analysis for wide-wavelength range demodulation for a plurality of FBGs, and has high practicability.

### BRIEF DESCRIPTION OF THE DRAWINGS

FIGS. 1A-1B are schematic diagrams of a structure of a dual-peak resonance LPFG and a schematic diagram of a transmittance spectrum of the dual-peak resonance LPFG, where FIG. 1A is a schematic diagram of the structure and a coupling mode of the dual-peak resonance LPFG, and FIG. 1B is a schematic diagram of the transmittance spectrum of the dual-peak resonance LPFG;

FIG. 2 is a schematic diagram of a demodulation system for cascaded FBGs based on a dual-peak resonance LPFG;

FIGS. 3A-3B are schematic diagrams of a demodulation principle, where FIG. 3A shows a tunable spectrum of a dual-peak resonance LPFG, that is, a piezoelectric ceramic is driven by a step wave to generate seven displacements which correspond to a-g seven spectrum changes of the dual-peak resonance LPFG in total, and FIG. 3B is a schematic diagram illustrating FBG demodulation in an I1 range, that is, a schematic diagram between a center wavelength change and a spectrum change when a center wavelength of the FBG shifts rightward by Δλ in the I1 range of a spectrum of the dual-peak resonance LPFG;

FIG. 4 is a schematic diagram of a structure of a six-axis strain sensor;

FIG. 5 shows seven spectrum charts obtained through control on a dual-peak resonance LPFG.

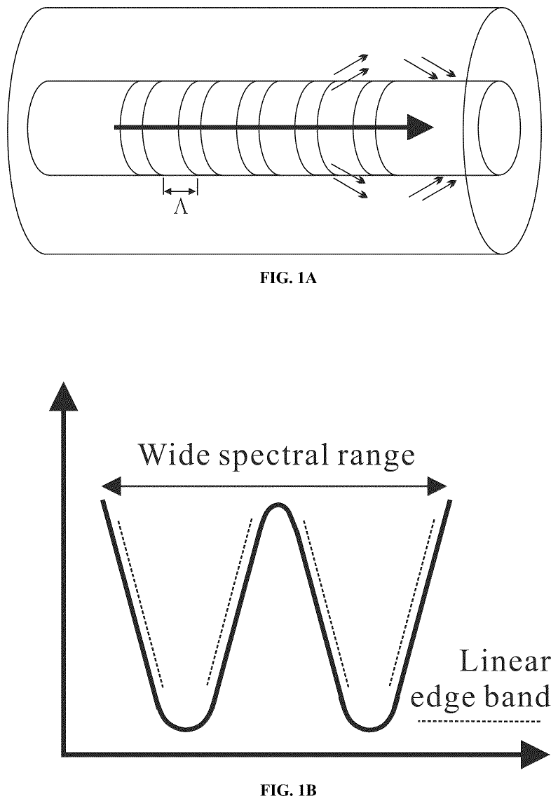

In the figures: 1, broadband light source; 2, piezoelectric ceramic; 3, dual-peak resonance LPFG; 4, optical isolator; 5, circulator; 6, attenuator; 7, photoelectric detector; 8, signal processing system; 9, computer; and 10, six-axis strain sensor.
10-1, bracket; 10-2, circular disc; 10-3, hollow cylindrical tube; 10-4, strain FBG; 10-5, optical fiber; 10-6, cover plate; 10-7, cylindrical cavity; 10-8, cylindrical encapsulation structure; 10-9, temperature FBG; and 10-10, base.

### DETAILED DESCRIPTION OF THE EMBODIMENTS

The present disclosure will be further described below in conjunction with specific embodiments.

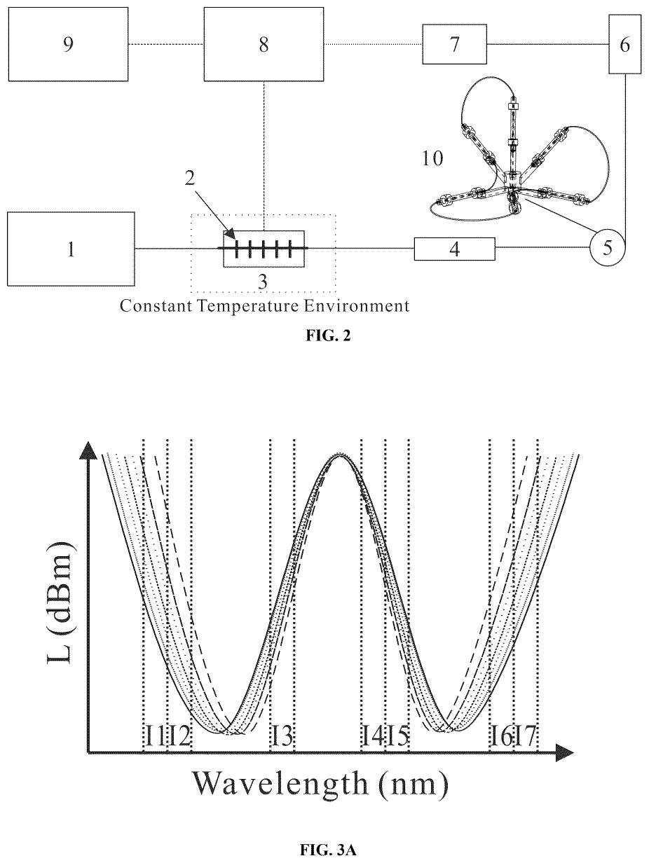

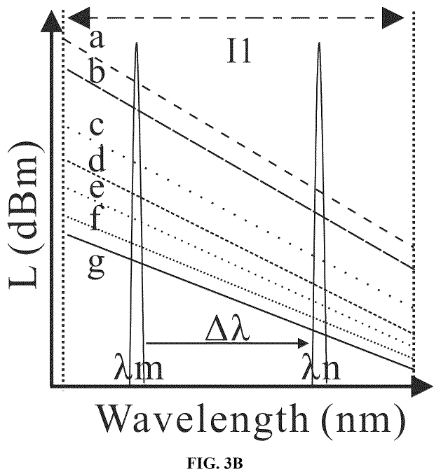

A wide-wavelength range demodulation method for cascaded FBGs of a six-axis strain sensor based on a tunable dual-peak resonance LPFG is implemented by using a demodulation system for the cascaded FBG of the tunable dual-peak resonance LPFG. As shown in FIG. 2, the demodulation system for the cascaded FBGs includes a broadband light source 1, a piezoelectric ceramic 2, a dual-peak resonance LPFG 3, an optical isolator 4, a circulator 5, an attenuator 6, a photoelectric detector 7, a signal processing system 8, and a computer 9. The broadband light source 1 is sequentially connected to the dual-peak resonance LPFG 3, the optical isolator 4, the attenuator 6, and the photoelectric detector 7 through an optical fiber; and the photoelectric detector 7, the signal processing system 8, and the computer 9 are connected through an electric wire. The dual-peak resonance LPFG 3 is used as a filter, and is configured to filter broadband laser emitted by the broadband light source 1 into a spectrum with four linear sidebands. The piezoelectric ceramic 2 is controlled by the signal processing system 8 to move, so that the dual-peak resonance LPFG 3 fixed on the piezoelectric ceramic 2 bends and deforms, to change a spectrum filtered by the dual-peak resonance LPFG 3. Light filtered by the dual-peak resonance LPFG 3 is only unidirectionally transmitted into the circulator 5 via the optical isolator 4, and light in the circulator 5 is not returned into the optical isolator 4. The attenuator 6 is configured to adjust an intensity of passed light to prevent the intensity of passed light from exceeding a measurement range of the photoelectric detector 7, and the photoelectric detector 7 is configured to: convert a sum of intensities of reflected light of the six-axis strain sensor 10 into a voltage value, and input the voltage value into the signal processing system 8 for storage. The photoelectric detector 7 in the demodulation system is configured to: obtain a sum of intensities of reflected light of seven FBGs, and convert the sum into a voltage value. Therefore, the key of the demodulation system is to perform seven controls on the spectrum of the dual-peak resonance LPFG 3 via the piezoelectric ceramic 2, so that the intensity of the reflected light is changed seven times when center wavelengths of the cascaded FBGs are not changed, and voltage values converted by the photoelectric detector 7 seven times are resolved to obtain center wavelength values of seven cascaded FBGs.

In the present disclosure, a CO₂ laser device is utilized to perform periodic inscription (with a period of 115 μm) on a single mode fiber with a diameter of 80 μm, to manufacture an LPFG 3 apparatus with dual-peak resonance, and a-g seven controls are performed on a spectrum of the LPFG 3 apparatus with dual-peak resonance, to obtain spectrum charts as shown in FIG. 5. Seven ranges I1 to I7 are divided in FIG. 5, which are sequentially ranges in which center wavelengths (k₁ to k₇) of seven cascaded FBGs in the six-axis strain sensor 10 deviate. Linear fitting is performed on each range of I1 to I7, to obtain a linear relationship between a center wavelength and a light intensity in different spectrum control modes (a-g) in each of the I1 to I7 ranges in Table 1.

TABLE 1

| | λ1 | λ2 | λ3 | λ4 |
|---|---|---|---|---|
| | 1270~1285 nm | 1285~1300 nm | 1360~1374 nm | 1374~1390 nm |
| a | La1 = −0.0647*λ1 + 81.5582 | La2 = −0.119*λ2 + 152.55 | La3 = 0.008968*λ3 − 133.888 | La4 = 0.08956*λ4 − 133.6809 |
| b | Lb1 = −0.0755*λ1 + 95.2401 | Lb2 = −0.133*λ2 + 170.22 | Lb3 = 0.11708*λ3 − 170.359 | Lb4 = 0.09191*λ4 − 135.7569 |
| c | Lc1 = −0.0903*λ1 + 113.835 | Lc2 = −0.154*λ2 + 196.06 | Lc3 = 0.12594*λ3 − 181.1 | Lc4 = 0.08728*λ4 − 127.9851 |
| d | Ld1 = −0.1011*λ1 + 127.331 | Ld2 = −0.168*λ2 + 213.06 | Ld3 = 0.12271*λ3 − 175.186 | Ld4 = 0.08241*λ4 − 12074263 |
| e | Le1 = −0.1235*λ1 + 155.503 | Le2 = −0.199*λ2 + 253.68 | Le3 = 0.10725*λ3 − 153.024 | Le4 = 0.07138*λ4 − 103.7682 |
| f | Lf1 = −0.1530*λ1 + 192.546 | Lf2 = −0.239*λ2 + 303.08 | Lf3 = 0.08755*λ3 − 124.538 | Lf4 = 0.05937*λ4 − 85.85366 |
| g | Lg1 = −0.2124*λ1 + 266.864 | Lg2 = −0.261*λ2 + 330.23 | Lg3 = 0.05792*λ3 − 82.0074 | Lg4 = 0.04044*λ4 − 58.01733 |

| | λ5 | λ6 | λ7 |
|---|---|---|---|
| | 1470~1490 nm | 1584~1595 nm | 1595~1606 nm |
| a | La5 = −0.08734*λ5 + 118.60304 | La6 = 0.07267*λ6 − 117.0886 | La7 = 0.0436*λ7 − 70.71395 |
| b | Lb5 = −0.09491*λ5 + 131.08982 | Lb6 = 0.08724*λ6 − 140.72909 | Lb7 = 0.05635*λ7 − 91.43855 |
| c | Lc5 = −0.0854*λ5 + 118.59498 | Lc6 = 0.10809*λ6 − 174.54727 | Lc7 = 0.07526*λ7 − 122.15775 |
| d | Ld5 = −0.07463*λ5 + 103.65722 | Ld6 = 0.12243*λ6 − 197.91932 | Ld7 = 0.08827*λ7 − 143.39054 |
| e | Le5 = −0.05502*λ5 + 76.27662 | Le6 = 0.14742*λ6 − 238.92084 | Le7 = 0.11964*λ7 − 194.56649 |
| f | Lf5 = −0.03881*λ5 + 53.78641 | Lf6 = 0.16967*λ6 − 276.12172 | Lf7 = 0.15697*λ7 − 255.82185 |
| g | Lg5 = −0.02335*λ5 + 32.75942 | Lg6 = 0.09013*λ6 − 152.771 | Lg7 = 0.17494*λ7 − 288.05189 |

According to a linear coefficient in Table 1, a coefficient matrix and a constrain item matrix in a demodulation model (7) are obtained.

$$K = [ \text{} \begin{matrix}- 0.0647 & - 0.119 & 0.08968 & 0.08956 & - 0.08734 & 0.07267 & 0.0436 \\ - 0.0755 & - 0.133 & 0.11708 & 0.09191 & - 0.09491 & 0.08724 & 0.05635 \\ - 0.0903 & - 0.154 & 0.12594 & 0.08728 & - 0.0824 & 0.10809 & 0.07526 \\ - 0.1011 & - 0.168 & 0.12271 & 0.08241 & - 0.07463 & 0.12243 & 0.08827 \\ - 0.1235 & - 0.199 & 0.10725 & 0.07138 & - 0.05502 & 0.14742 & 0.11964 \\ - 0.153 & - 0.239 & 0.08755 & 0.05937 & - 0.03881 & 0.16967 & 0.15697 \\ - 0.2124 & - 0.261 & 0.05792 & 0.04044 & - 0.02335 & 0.09013 & 0.17494\end{matrix} ] ,$$

$$M = [ \begin{matrix}- 102.66 \\ - 141.734 \\ - 177.3 \\ - 192.934 \\ - 204.82 \\ - 192.923 \\ 49.0058\end{matrix} ]$$

Finally, two groups of center wavelengths and corresponding total intensities of reflected light of the FBGs are selected, center wavelengths of the seven cascaded FBGs in the six-axis strain sensor are demodulated through the demodulation model (7) with a determined parameter, and resolution values are compared with actual values to obtain errors. The demodulation method in the present disclosure is verified to be feasible with reference to specific embodiments.

| | | | | | | | |
|---|---|---|---|---|---|---|---|
| Actual wavelength (nm) | 1282 | 1297.2 | 1371.6 | 1389.7 | 1485.7 | 1592.7 | 1605.6 |
| Solution wavelength (nm) | 1284.1 | 1296.1 | 1371.9 | 1391.5 | 1487 | 1591.6 | 1606.8 |
| Error (nm) | −2.1 | 1.1 | −0.3 | −1.8 | −1.3 | 1.1 | −1.2 |
| Actual wavelength (nm) | 1273.4 | 1288.6 | 1363.1 | 1379.6 | 1474.3 | 1586.5 | 1598 |
| Solution wavelength (nm) | 1278.1 | 1283.9 | 1364.7 | 1377.1 | 1474.3 | 1584.2 | 1597.8 |
| Error (nm) | −4.7 | 4.7 | −1.6 | 2.5 | 0 | 2.3 | 0.2 |

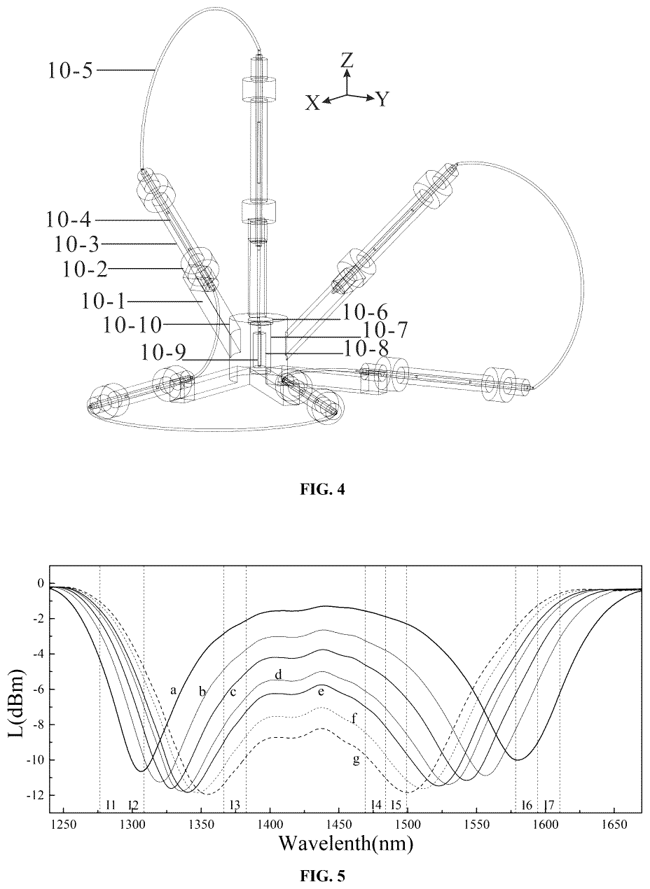

The cascaded FBGs are fiber grating six-axis strain sensors. As shown in FIG. 4, and the fiber grating six-axis strain sensor has six strain sensing units of a same structure, that are arranged in six spatial directions of X, Y, Z, XY, XZ, and YZ, and also has a temperature sensing unit arranged inside a base of the six-axis multidimensional strain sensor to achieve temperature compensation in a strain measurement process of the six-axis multidimensional strain sensor. The fiber grating six-axis strain sensor mainly includes a bracket 10-1, the base 10-10, the six strain sensing units that are respectively disposed in six directions and have a same structure, the temperature sensing unit, an optical fiber 10-5, a cylindrical encapsulation structure 10-8, and a temperature FBG 10-9, where each of the six strain sensing units includes two circular discs 10-2, a hollow cylindrical tube 10-3, and a strain FBG 10-4; and the temperature sensing unit includes a cover plate 10-6, a cylindrical cavity 10-7, and the cylindrical encapsulation structure 10-8. Components other than the strain FBG 10-4 and the optical fiber 10-5 are integrally manufactured through 3D printing, and are mutually integrated.

The bracket 10-1 is configured to support the six stain sensing units in the six spatial directions of X, Y, Z, XY, XZ, and YZ, and each of the six strain sensing units includes two circular discs 10-2, one hollow cylindrical tube 10-3, and the strain (FBG) 4 encapsulated inside the hollow cylindrical tube 10-3. The strain FBG 10-4 is located in a center of the hollow cylindrical tube 10-3, the strain FBG 10-4 on two ends of the hollow cylindrical tube 10-3 is fixed with an inner wall of the tube by using a fixative, so that the FBG 10-4 has synchronous deformation with the hollow cylindrical tube 10-3 during strain measurement while the FBG 10-4 is prevented from a chirp phenomenon. The two circular discs 10-2 are arranged on an outer wall surface of the hollow cylindrical tube 10-3, the hollow cylindrical tube 10-3 and the two circular discs 10-2 form a dumbbell-like hollow structure, and the circular disc 10-2 is configured to prevent sliding relative to a measured object in a measurement process. Bottoms of the six strain sensing units are fixed on the base 10-10. The base 10-10 is of a hollow cylindrical structure, and is internally nested with a coaxial hollow circular tube, the cylindrical encapsulation structure 10-8 and the temperature FBG 10-9 are disposed in the circular tube, the cover plate 10-6 is disposed on a top of the circular tube, a through hole for allowing the strain FBG 10-4 to pass through is formed in the middle of the cover plate, and the strain FBG 10-4 is connected to the temperature FBG 10-9. The cylindrical cavity 10-7 is provided between the cylindrical encapsulation structure 10-8 and the cover plate 10-6.

In this embodiment, the six-axis strain sensor is manufactured to measure multidimensional complex strains in internal space of frozen soil. White nylon with high tenacity is selected as a section bar, and an integrated body structure of the six-axis strain sensor in FIG. 4 is manufactured through 3D printing technology, including the bracket 10-1, the circular disc 10-2, the hollow cylindrical tube 10-3, and the base 10-10. The circular disc 10-2 has a diameter of 5 mm and a height of 3 mm. A distance between two circular discs 10-2 is 25 mm. A diameter of a hollow hole of the hollow cylindrical tube 10-3 is 1 mm. The cylindrical encapsulation structure 10-8 is also manufactured through 3D printing, is made of the white nylon material, and also has a hole diameter of 1 mm.

A first FBG 10-4 of the seven cascaded FBGs-4 is encapsulated in the cylindrical encapsulation structure 10-8 by using epoxy resin, and is placed into the cavity 10-7 inside the base 10-10, and the cavity 10-7 is sealed by the cover plate 10-6 to form a temperature sensing unit of the six-axis multidimensional strain sensor. The rest of FBGs-4 are sequentially encapsulated into corresponding hollow cylindrical tubes 10-3 by using the epoxy resin in a sequence of Z, XZ, X, XY, Y, and YZ, and finally an optical fiber is guided out from an inner end of the hollow cylindrical tube in the YZ direction as a transmission line for a sensing signal during measurement. A distribution status of center wavelengths of the cascaded FBGs-4 of the sensor is shown.

The finally designed fiber grating six-axis strain sensor is capable of converting strains, in the six spatial directions of X, Y, Z, XY, XZ, and YZ, inside the measured object into changes of center wavelength values (λ_{FBG}) corresponding to cascaded FBGs of the six-axis multidimensional strain sensor to implement measurement of the six-axis multidimensional strain sensor. The principle is as follows:

Interferences of a temperature and a strain on λ_{FBG} are independent and linear (as shown in formula 1),

$${Δλ}_{FBG} = {k}_{T} Δ T + {k}_{ε} Δε \qquad ( 1 )$$

k_{T} indicates a temperature coefficient of a FBG, k_{ε} indicates a strain coefficient of the FBG, ΔT and Δε respectively indicate a variation of the temperature and a variation of the strain. Therefore, a temperature of the measured object can be calculated according to a center wavelength offset of the temperature sensing unit of the six-axis multidimensional strain sensor, to eliminate center wavelength offsets, caused by temperatures, of the strain sensing units in the six directions, so as to implement temperature compensation for strain measurement. Strains (εₓ, ε_{y}, ε_{z}, ε_{xy}, ε_{xz}, ε_{yz}) in the six spatial directions of X, Y, Z, XY, XZ, and YZ, can be obtained according to changes of center wavelengths of the seven cascaded FBGs in the sensor, as shown in formula (2), where T₀ and ε₀ are initial values of the temperature and the strain. Formula (2) is a mathematical model designed for the six-axis strain sensor.

$$[ \begin{matrix}{ε}_{x} \\ {ε}_{y} \\ {ε}_{z} \\ {ε}_{xy} \\ {ε}_{xz} \\ {ε}_{yz} \\ T\end{matrix} ] = [ \begin{matrix}{k}_{ε x}^{- 1} & 0 & 0 & 0 & 0 & 0 & - {{k}_{Tx} ( {k}_{T} {k}_{ε x} )}^{- 1} \\ 0 & {k}_{ε y}^{- 1} & 0 & 0 & 0 & 0 & - {{k}_{Ty} ( {k}_{T} {k}_{ε y} )}^{- 1} \\ 0 & 0 & {k}_{ε z}^{- 1} & 0 & 0 & 0 & - {{k}_{Tz} ( {k}_{T} {k}_{ε z} )}^{- 1} \\ 0 & 0 & 0 & {k}_{ε xy}^{- 1} & 0 & 0 & - {{k}_{Txy} ( {k}_{T} {k}_{ε xy} )}^{- 1} \\ 0 & 0 & 0 & 0 & {k}_{ε xz}^{- 1} & 0 & - {{k}_{Txz} ( {k}_{T} {k}_{ε xz} )}^{- 1} \\ 0 & 0 & 0 & 0 & 0 & {k}_{ε yz}^{- 1} & - {{k}_{Txz} ( {k}_{T} {k}_{ε xz} )}^{- 1} \\ 0 & 0 & 0 & 0 & 0 & 0 & {k}_{T}\end{matrix} ] [ \begin{matrix}Δ {λ}_{x} \\ Δ {λ}_{y} \\ {Δλ}_{z} \\ Δ {λ}_{xy} \\ Δ {λ}_{xz} \\ Δ {λ}_{yz} \\ {Δλ}_{T}\end{matrix} ] + [ \begin{matrix}{ε}_{x 0} \\ {ε}_{y 0} \\ {ε}_{z 0} \\ {ε}_{xy 0} \\ {ε}_{xz 0} \\ {ε}_{yz 0} \\ {T}_{0}\end{matrix} ] \qquad ( 2 )$$

A group of strain values, measured by the sensor, in the six directions are substituted into a formula (3) to obtain six basic strain components (εₓ, ε_{y}, ε_{z}, γ_{xy}, γ_{yz}, γ_{xz}) that indicate spatial strains.

$$\begin{matrix}{γ}_{xy} = 2 {ε}_{xy} - {ε}_{x} - {ε}_{y} \\ {γ}_{yz} = 2 {ε}_{yz} - {ε}_{y} - {ε}_{z} \\ {γ}_{zx} = 2 {ε}_{zx} - {ε}_{z} - {ε}_{x}\end{matrix} \qquad ( 3 )$$

γ_{xy}, γ_{yz}, and γ_{zx} respectively indicate shear strains in an XY plane, a YZ plane, and a ZX plane in space. A normal strain and a shear strain of a measured point on any section can be obtained through the six basic strain components. Therefore, a strain state, in three-dimensional space, of the point can be completely determined through the six strain components. The strain components are substituted into a spatial principal strain equation (4).

$${ε}^{3} - {I}_{1} {ε}^{2} + {I}_{2} ε - {I}_{3} = 0 \qquad ( 4 )$$

I₁, I₂, and I₃ in the formula (4) are respectively a first invariant, a second invariant, and a third invariant of a strain tensor, which can be calculated according to the formula (5).

$$\begin{matrix}{I}_{1} = {ε}_{x} + {ε}_{y} + {ε}_{z} \\ {I}_{2} = {ε}_{y} {ε}_{z} + {ε}_{z} {ε}_{x} + {ε}_{x} {ε}_{y} - \frac{{γ}_{zx}^{2} + {γ}_{yz}^{2} + {γ}_{xy}^{2}}{4} \\ {I}_{3} = {ε}_{x} {ε}_{y} {ε}_{z} - \frac{{ε}_{x} {γ}_{yz}^{2} + {ε}_{y} {γ}_{zx}^{2} + {ε}_{z} {γ}_{xy}^{2}}{4} + \frac{{γ}_{xy} + {γ}_{yz} + {γ}_{zx}}{4}\end{matrix} \qquad ( 5 )$$

The spatial principal strain equation (4) is resolved according to the formula (5), so that sizes of a first principal strain si, a second principal strain ε₂, and a third strain ε₃ can be obtained. A principal strain direction cosine equation set (6) is introduced to determine a direction of the principal strain.

$$\{ \begin{matrix}2 ( {ε}_{x} - {ε}_{i} ) l + {γ}_{xy} m + {γ}_{zx} n = 0 \\ {γ}_{xy} l + 2 ( {ε}_{y} - {ε}_{i} ) m + {γ}_{yz} n = 0 \\ {γ}_{zx} l + {γ}_{yz} m + 2 ( {ε}_{z} - {ε}_{i} ) n = 0\end{matrix} \qquad ( 6 )$$

ε₁, ε₂, and ε₃ are sequentially substituted into εᵢ in the formula (6) to obtain direction cosine values 1, m and n of included angles between the principal strain and three coordinate axes: X, Y, and Z, which satisfy the following relationship:

$${l}^{2} + {m}^{2} + {n}^{2} = 1 \qquad ( 7 )$$

According to the cosine values of the principal strain on the coordinate axes, an angle between the principal strain and each coordinate axis can be calculated according to formula (7), where θₓ indicates an included with the X-axis, θ_{y} indicates an included angle with the Y-axis, and θ_{z} indicates an included angle with the Z-axis. A principal strain distribution status in the three-dimensional space can be finally determined according to a size and direction of the principal strain.

$$\begin{matrix}{θ}_{X} = arc cos l & l ∈ [ - 1 , 1 ] \\ {θ}_{Y} = arc cos m & m ∈ [ - 1 , 1 ] \\ {θ}_{Z} = arc cos n & n ∈ [ - 1 , 1 ]\end{matrix} \qquad ( 8 )$$

The foregoing embodiments are merely implementations of the present disclosure, and should not be understood as limitations to the range of the present disclosure, and it should be noted that various modifications and variations further can be made by those skilled in the art without departing from the conception of the present disclosure and are within the scope of the present disclosure.

What is claimed is:

1. A wide-wavelength range demodulation method for cascaded fiber Bragging gratings (FBGs) of a six-axis multidimensional strain sensor based on a tunable dual-peak resonance long-period fiber grating (LPFG), wherein the demodulation method is implemented by using a demodulation system for the cascaded FBGs based on the tunable dual-peak resonance LPFG; the demodulation system for the cascaded FBGs comprises a broadband light source (1), a piezoelectric ceramic (2), a dual-peak resonance LPFG (3), an optical isolator (4), a circulator (5), an attenuator (6), a photoelectric detector (7), a signal processing system (8), and a computer (9), wherein the broadband light source (1) is sequentially connected to the dual-peak resonance LPFG (3), the optical isolator (4), the circulator (5), the attenuator (6), and the photoelectric detector (7) through an optical fiber, the dual-peak resonance LPFG (3) is fixed on the piezoelectric ceramic (2), and a six-axis strain sensor (10) is connected to the circulator (5); and the photoelectric detector (7), the signal processing system (8), and the computer (9) are connected through an electric wire, wherein the signal processing system (8) is connected to the piezoelectric ceramic (2); and
in the demodulation method, laser emitted by the broadband light source (1) is filtered by the dual-peak resonance LPFG (3) to form a transmittance spectrum with four linear sidebands; the piezoelectric ceramic (2) is controlled by the signal processing system (8) to move, so that the dual-peak resonance LPFG (3) fixed on the piezoelectric ceramic (2) bends and deforms, to change a spectrum filtered by the dual-peak resonance LPFG (3); and laser passing through the dual-peak resonance LPFG (3) enters the circulator (5) through the optical isolator (4) and then is incident to the cascaded FBGs of the six-axis strain sensor (10); and reflected light of the cascaded FBGs enters the photoelectric detector (7) through the circulator (5) and the attenuator (6), and the photoelectric converter (7) is configured to: convert a sum of intensities of reflected light of the cascaded FBGs into a voltage value, and input the voltage value into the signal processing system (8).

2. The wide-wavelength range demodulation method for cascaded FBGs of a six-axis multidimensional strain sensor based on a tunable dual-peak resonance LPFG according to claim 1, wherein the fiber grating six-axis strain sensor (10) is a fiber grating six-axis strain sensing unit, has six strain sensing units of a same structure that are arranged in six spatial directions of X, Y, Z, XY, XZ, and YZ, and also has a temperature sensing unit arranged inside a base of the six-axis multidimensional strain sensor to achieve temperature compensation in a strain measurement process of the six-axis multidimensional strain sensor; specifically, the fiber grating six-axis strain sensing unit comprises a bracket (10-1), the base (10-10), the six strain sensing units that are respectively disposed in the six directions and have the same structure, the temperature sensing unit, an optical fiber (10-5), a cylindrical encapsulation structure (10-8), and a temperature FBG (10-9); each of the six strain sensing units comprises two circular discs (10-2), a hollow cylindrical tube (10-3), and a strain FBG (10-4); and the temperature sensing unit comprises a cover plate (10-6), a cylindrical cavity (10-7), and the cylindrical encapsulation structure (10-8); and specifically:
the bracket (10-1) is configured to support the six stain sensing units in the six spatial directions of X, Y, Z, XY, XZ, and YZ, and each of the strain sensing units comprises two circular discs (10-2), one hollow cylindrical tube (10-3), and the strain FBG (10-4) encapsulated inside the hollow cylindrical tube (10-3); the FBG (10-4) is located in a center of the hollow cylindrical tube (10-3), and is fixed with an inner wall of the tube by using a fixative; the two circular discs (10-2) are arranged outside the hollow cylindrical tube (10-3), and the circular disc (10-2) is configured to prevent sliding relative to a measured object in a measurement process; bottoms of the six strain sensing units are fixed on the base (10-10); the base (10-10) is of a hollow cylindrical structure, and is internally nested with a coaxial hollow circular tube, the cylindrical encapsulation structure (10-8) and the temperature FBG (10-9) are disposed in the circular tube, the cover plate (10-6) is disposed on a top of the circular tube, and a through hole for allowing the strain FBG (10-4) to pass through is formed in a middle of the cover plate; the cylindrical cavity (10-7) is provided between the cylindrical encapsulation structure (10-8) and the cover plate (10-6); seven FBGs comprising six strain FBGs (10-4) and one temperature FBG (10-9) are cascaded together and are arranged in the six-axis strain sensor (10) in sequence; the one temperature FBG (10-9) is arranged in a bottom cavity of the strain sensing unit in the Z direction, to eliminate temperature interference in the measurement process, and perform temperature compensation as the temperature sensing unit; and the obtained six-axis strain sensor (10) is capable of converting strains, in the six spatial directions of X, Y, Z, XY, XZ, and YZ, inside the measured object into changes of center wavelength values of cascaded FBGs of the six-axis multidimensional strain sensor, to implement measurement of the six-axis multidimensional strain sensor.

3. The wide-wavelength range demodulation method for cascaded FBGs of a six-axis multidimensional strain sensor based on a tunable dual-peak resonance LPFG according to claim 2, wherein the seven FBGs in the six-axis strain sensor (10) are arranged as follows:
one end that is of the hollow cylindrical tube (10-3) and that is close to the base (10-10) is defined as an inner end, and the other end of the hollow cylindrical tube (10-3) is defined as an outer end; a first FBG (10-4) gets in from the outer end of the hollow cylindrical tube (10-3) in the YZ direction and is fixed in the hollow cylindrical tube (10-3) in the YZ direction; after the first FBG (10-4) is fixed, an optical fiber guided out from the outer end of the hollow cylindrical tube (10-3) in the YZ direction gets in the hollow cylindrical tube (10-3) in the Y direction, and a second FBG (10-4) is fixed in the hollow cylindrical tube (10-3) in the Y direction; an optical fiber guided out from the inner end of the hollow cylindrical tube (10-3) in the Y direction gets in from the inner end of the hollow cylindrical tube (10-3) in the XY direction, and a third FBG (10-4) is fixed in the hollow cylindrical tube (10-3) in the XY direction; an optical fiber guided out from the outer end of the hollow cylindrical tube (10-3) in the XY direction gets in from the outer end of the hollow cylindrical tube (10-3) in the X direction, and a fourth FBG (10-4) is fixed in the hollow cylindrical tube (10-3) in the X direction; an optical fiber guided out from the inner end of the hollow cylindrical tube (10-3) in the X direction gets in from the inner end of the hollow cylindrical tube (10-3) in the XZ direction, and a fifth FBG (10-4) is fixed in the hollow cylindrical tube (10-3) in the XZ direction; an optical fiber guided out from the outer end of the hollow cylindrical tube (10-3) in the XZ direction gets in from the outer end of the hollow cylindrical tube (10-3) in the Z direction, and a sixth FBG (10-4) is fixed in the hollow cylindrical tube (10-3) in the Z direction; and an optical fiber (a tail end of which is provided with the temperature FBG (9)) guided out from an inner end of the hollow cylindrical tube (3) in the Z direction gets into the cavity (10-7) of the base (10-10), thereby completing arrangement of the seven FBGs.

4. The wide-wavelength range demodulation method for cascaded FBGs of a six-axis multidimensional strain sensor based on a tunable dual-peak resonance LPFG according to claim 1, wherein
the photoelectric detector (7) is configured to: obtain a sum of intensities of reflected light of the seven FBGs of the six-axis strain sensor (10), and convert the sum into a voltage value;
seven controls are performed on the spectrum of the dual-peak resonance LPFG (3) via the piezoelectric ceramic (2), so that the intensity of the reflected light is changed seven times when the center wavelengths of the cascaded FBGs of the six-axis strain sensor (10) are not changed, and voltage values converted by the photoelectric detector (7) seven times are resolved to obtain center wavelength values of the seven cascaded FBGs; and
the piezoelectric ceramic (2) is controlled by the signal processing system (8) to move, so that the dual-peak resonance LPFG (3) fixed on the piezoelectric ceramic (2) bends and deforms, changing the transmittance spectrum of the dual-peak resonance LPFG (3); after the transmittance spectrum of the LPFG (3) is changed, the intensities of the reflected light of the cascaded FBGs change while the center wavelengths of the cascaded FBGs of the six-axis strain sensor are not changed, so that an output voltage of the photoelectric detector (7) finally changes; the piezoelectric ceramic (2) is capable of being controlled by the signal processing system (8) to move seven times, and seven different voltage values are correspondingly output by the photoelectric detector (7), and are recorded in the signal processing system (8); the signal processing system (8) is configured to substitute the seven recorded voltage values into a demodulation model to obtain seven center wavelengths of the cascaded FBGs of the six-axis strain sensor (10), and the seven center wavelengths are displayed on the computer (9); and wide-wavelength range demodulation for the seven cascaded FBGs in the six-axis strain sensor (10) is implemented.

5. The wide-wavelength range demodulation method for cascaded FBGs of a six-axis multidimensional strain sensor based on a tunable dual-peak resonance LPFG according to claim 4, wherein the demodulation model is as follows: during spatial strain monitoring, the seven FBGs are needed, and the demodulation model is provided for describing the seven cascaded FBGs; the seven FBGs with different center wavelengths are defined as FBGX, FBGYZ, FBGXY, FBGY, FBGXZ, FBGZ, and FBGT that are sequentially distributed on four linear sidebands of the dual-peak resonance LPFG, and I1 to I7 are ranges in which the center wavelength of each FBG deviates; and the piezoelectric ceramic (2) is controlled by the signal processing system (8), so that the transmittance spectrum of the dual-peak resonance LPFG (3) changes regularly in sequence, and is sequentially recorded as spectrums a-g; and
when the transmittance spectrum of the dual-peak resonance LPFG (3) is a, a correspondence between a center wavelength λᵢ of the FBG within the ranges of I1 to I7 and light intensity L is follows:
$${L}_{ai} = {k}_{ai} {λ}_{i} + {m}_{ai} , \\ where \\ i = 1 - 7 ; \qquad ( 1 )$$
a signal acquired by the photoelectric detector (7) is a total intensity of reflected light within the seven ranges, and the total intensity of reflected light of the seven FBGs in an optical path is converted into a voltage value U; and an output voltage Uₐ of the photoelectric detector (7) is represented as formula (2), wherein β is a conversion coefficient between an intensity of input light of the photoelectric detector (7) and the output voltage U, and is an inherent characteristic of the photoelectric detector (7);
$${U}_{a} = β {\sum }_{i = 1}^{7} {L}_{ai} = β [ ( {k}_{a 1} {λ}_{1} + {k}_{a 2} {λ}_{2} + {k}_{a 3} {λ}_{3} + {k}_{a 4} {λ}_{4} + {k}_{a 5} {λ}_{5} + {k}_{a 6} {λ}_{6} + {k}_{a 7} {λ}_{7} ) + {\sum }_{i = 1}^{7} {m}_{ai} ] , \qquad ( 2 )$$
when the transmittance spectrum of the dual-peak resonance LPFG (3) is j (j=a−g), a voltage Uⱼ output by the photoelectric detector (7) is as follows:
$${U}_{j} = β {\sum }_{i = 1}^{7} {L}_{ji} \qquad ( 3 )$$
in a complete demodulation process, the spectrum of the dual-peak resonance LPFG (3) is controlled seven times via the piezoelectric ceramic (2), the photoelectric detector (7) is capable of obtaining seven voltage values Uₐ to U_{g}, and the demodulation model shown in formula (7) is finally obtained; and
$${U}_{a} = β {\sum }_{i = 1}^{7} {L}_{ai} = β [ ( {k}_{a 1} {λ}_{1} + {k}_{a 2} {λ}_{2} + {k}_{a 3} {λ}_{3} + {k}_{a 4} {λ}_{4} + {k}_{a 5} {λ}_{5} + {k}_{a 6} {λ}_{6} + {k}_{a 7} {λ}_{7} ) + {\sum }_{i = 1}^{7} {m}_{ai} ] \\ {U}_{b} = β {\sum }_{i = 1}^{7} {L}_{bi} = β [ ( {k}_{b 1} {λ}_{1} + {k}_{b 2} {λ}_{2} + {k}_{b 3} {λ}_{3} + {k}_{b 4} {λ}_{4} + {k}_{b 5} {λ}_{5} + {k}_{b 6} {λ}_{6} + {k}_{b 7} {λ}_{7} ) + {\sum }_{i = 1}^{7} {m}_{bi} ] \\ {U}_{c} = β {\sum }_{i = 1}^{7} {L}_{ci} = β [ ( {k}_{c 1} {λ}_{1} + {k}_{c 2} {λ}_{2} + {k}_{c 3} {λ}_{3} + {k}_{c 4} {λ}_{4} + {k}_{c 5} {λ}_{5} + {k}_{c 6} {λ}_{6} + {k}_{c 7} {λ}_{7} ) + {\sum }_{i = 1}^{7} {m}_{ci} ] \\ {U}_{d} = β {\sum }_{i = 1}^{7} {L}_{di} = β [ ( {k}_{d 1} {λ}_{1} + {k}_{d 2} {λ}_{2} + {k}_{d 3} {λ}_{3} + {k}_{d 4} {λ}_{4} + {k}_{d 5} {λ}_{5} + {k}_{d 6} {λ}_{6} + {k}_{d 7} {λ}_{7} ) + {\sum }_{i = 1}^{7} {m}_{di} ] \\ {U}_{e} = β {\sum }_{i = 1}^{7} {L}_{ei} = β [ ( {k}_{e 1} {λ}_{1} + {k}_{e 2} {λ}_{2} + {k}_{e 3} {λ}_{3} + {k}_{e 4} {λ}_{4} + {k}_{e 5} {λ}_{5} + {k}_{e 6} {λ}_{6} + {k}_{e 7} {λ}_{7} ) + {\sum }_{i = 1}^{7} {m}_{ei} ] \\ {U}_{f} = β {\sum }_{i = 1}^{7} {L}_{fi} = β [ ( {k}_{f 1} {λ}_{1} + {k}_{f 2} {λ}_{2} + {k}_{f 3} {λ}_{3} + {k}_{f 4} {λ}_{4} + {k}_{f 5} {λ}_{5} + {k}_{f 6} {λ}_{6} + {k}_{f 7} {λ}_{7} ) + {\sum }_{i = 1}^{7} {m}_{fi} ] \\ {U}_{g} = β {\sum }_{i = 1}^{7} {L}_{gi} = β [ ( {k}_{g 1} {λ}_{1} + {k}_{g 2} {λ}_{2} + {k}_{g 3} {λ}_{3} + {k}_{g 4} {λ}_{4} + {k}_{g 5} {λ}_{5} + {k}_{g 6} {λ}_{6} + {k}_{g 7} {λ}_{7} ) + {\sum }_{i = 1}^{7} {m}_{gi} ] \qquad ( 7 )$$
in the model, both a linear coefficient kⱼᵢ (j=a to j, and i=1-7) and constant items Mₐ to M_{g} are determined based on the linear sidebands of the transmittance spectrum of the dual-peak resonance LPFG (3), and both are known; and therefore, when the output voltages Uₐ to U_{g} of the photoelectric detector are known, center wavelengths λ₁ to λ₇ of the seven cascaded FBGs in the six-axis strain sensor (10) are calculated.
